(19) United States
(12) Patent Application Publication
(10) Pub. No.: US 2026/0292145 A1
(43) Pub. Date: Sep. 24, 2026

(54) NON-REFRESHED AREA HANDLING FOR FLEXIBLE GDR

(71) Applicant: Nokia Technologies Oy, Espoo (FI)

(72) Inventors: Limin WANG, San Diego, CA (US); Seungwook HONG, San Diego, CA (US); Krit PANUSOPONE, San Diego, CA (US)

(21) Appl. No.: 19/476,012

(22) PCT Filed: Mar. 12, 2024
(86) PCT No.: PCT/EP2024/056472

§ 371 Date: Oct. 16, 2025

Related U.S. Application Data
(60) Provisional application No. 63/496,563, filed on Apr. 17, 2023.

(51) Int. Cl. H04N 19/107; H04N 19/136; H04N 19/172; H04N 19/182

(52) U.S. Cl. CPC H04N 19/107; H04N 19/136; H04N 19/172; H04N 19/182

(57) ABSTRACT

A method including determining a refreshed area of a picture or portion of a picture, where the refreshed area comprises at least one first pixel; determining a non-refreshed area of the picture or portion of the picture; determining an updated value for a second pixel in the non-refreshed area based, at least partially, upon a value of the at least one first pixel in the refreshed area; updating the second pixel with the updated value; and determining a value of a third pixel in the non-refreshed area based, at least partially, upon the determined updated value for the second pixel in the non-refreshed area.

### TECHNICAL FIELD

The examples and non-limiting embodiments relate generally to multimedia transport and information encoding and decoding and, more particularly, to filters at virtual boundaries.

### BRIEF DESCRIPTION OF PRIOR DEVELOPMENTS

It is known to perform data compression and decoding in a multimedia system.

### SUMMARY OF THE INVENTION

The following summary is merely intended to be an example. The summary is not intended to limit the scope of the claims.

In accordance with one aspect, an example method is provided comprising: determining a refreshed area of a picture or portion of a picture, where the refreshed area comprises at least one first pixel; determining a non-refreshed area of the picture or portion of the picture; determining an updated value for a second pixel in the non-refreshed area based, at least partially, upon a value of the at least one first pixel in the refreshed area; updating the second pixel with the updated value; and determining a value of a third pixel in the non-refreshed area based, at least partially, upon the determined updated value for the second pixel in the non-refreshed area.

In accordance with another aspect, an example apparatus is provided comprising: at least one processor; and at least one non-transitory memory storing instructions that, when executed with the at least one processor, cause the apparatus to perform: determining a refreshed area of a picture or portion of a picture, where the refreshed area comprises at least one first pixel; determining a non-refreshed area of the picture or portion of the picture; determining an updated value for a second pixel in the non-refreshed area based, at least partially, upon a value of the at least one first pixel in the refreshed area; updating the second pixel with the updated value; and determining a value of a third pixel in the non-refreshed area based, at least partially, upon the determined updated value for the second pixel in the non-refreshed area.

In accordance with another aspect, an example apparatus is provided comprising: means for determining a refreshed area of a picture or portion of a picture, where the refreshed area comprises at least one first pixel; means for determining a non-refreshed area of the picture or portion of the picture; means for determining an updated value for a second pixel in the non-refreshed area based, at least partially, upon a value of the at least one first pixel in the refreshed area; means for updating the second pixel with the updated value; and means for determining a value of a third pixel in the non-refreshed area based, at least partially, upon the determined updated value for the second pixel in the non-refreshed area.

In accordance with another aspect, an example embodiment is provided with a non-transitory program storage device readable by an apparatus, tangibly embodying a program of instructions executable with the apparatus for performing operations, the operations comprising: determining a refreshed area of a picture or portion of a picture, where the refreshed area comprises at least one first pixel; determining a non-refreshed area of the picture or portion of the picture; determining an updated value for a second pixel in the non-refreshed area based, at least partially, upon a value of the at least one first pixel in the refreshed area; updating the second pixel with the updated value; and determining a value of a third pixel in the non-refreshed area based, at least partially, upon the determined updated value for the second pixel in the non-refreshed area.

According to some aspects, there is provided the subject matter of the independent claims. Some further aspects are provided in subject matter of the dependent claims.

### BRIEF DESCRIPTION OF DRAWINGS

The foregoing aspects and other features are explained in the following description, taken in connection with the accompanying drawings, wherein:

FIG. 1 shows schematically an electronic device employing embodiments of the examples described herein;

FIG. 2 shows schematically a user equipment suitable for employing embodiments of the examples described herein;

FIG. 3 further shows schematically electronic devices employing embodiments of the examples described herein connected using wireless and wired network connections;

FIG. 4 shows schematically a block chart of an encoder used for data compression on a general level;

FIG. 5 illustrates that a refreshed area is not allowed to use coding information of a non-refreshed area;

FIG. 6 illustrates that a non-refreshed area is allowed to use coding information of a refreshed area;

FIG. 7 shows that deblocking may not be applied to pixels pᵢ, i=0, 1, 2, or still applied with pixels qᵢ, i=0, 1, 2, in the non-refreshed area padded;

FIG. 8 is a diagram illustrating some example components of an example apparatus;

FIG. 9 is a diagram illustrating a current GDR design in VVC/ECM design with an initial refreshed area that starts on the left of a GDR picture and then gradually expands to the right over the associated recovering pictures;

FIG. 10 is a copy of a video game picture;

FIG. 11 is a copy of a daylight picture;

FIG. 12 is a diagram illustrating an initial refreshed area (RA) located in a middle of a GDR picture and then gradually expands to the left and the right sides of the associated recovering pictures;

FIG. 13 is a diagram illustrating an initial refreshed area (RA) in a center of a GDR picture and then gradually expands in four directions over the associated recovering pictures;

FIG. 14 is a diagram illustrating an initial refreshed area (RA) located at a left of a picture where pixels in the refreshed area are repeated into the non-refreshed area horizontally to the right;

FIG. 15 is a diagram illustrating an initial refreshed area (RA) located in a middle of a GDR picture and then gradually expands, where pixels in the refreshed area are repeated into the non-refreshed area horizontally both left and right;

FIG. 16 is a diagram illustrating an initial refreshed area (RA) located at a top of a picture, where pixels in the refreshed area are repeated into the non-refreshed area vertically down;

FIG. 17 is a diagram illustrating an initial refreshed area (RA) located in a middle of a GDR picture and then gradually expands, where pixels in the refreshed area are repeated into the non-refreshed area vertically both up and down;

FIG. 18 is a diagram illustrating an initial refreshed area (RA) located in a middle of a GDR picture and then gradually expands, initially both to the left and right, and subsequently both up and down;

FIG. 19 is a diagram illustrating an initial refreshed area (RA) located in a middle of a GDR picture and then gradually expands, initially both up and down, and subsequently both left and right;

FIG. 20 is a diagram illustrating four (4) initial refreshed areas (RA) located at corners of a GDR picture and then gradually expands inward in horizontal and vertical directions;

FIG. 21 is a diagram illustrating an initial refreshed area (RA) located in a middle of a GDR picture and then gradually expands, into four (4) corners;

FIG. 22 is a flow diagram illustrating an example method.

### DETAILED DESCRIPTION

The following acronyms and abbreviations that may be found in the specification and/or the drawing figures are defined as follows. The acronyms and abbreviations may be appended with each other and/or other characters (e.g. a hyphen (-)).
3GPP 3rd generation partnership project
4G fourth generation of broadband cellular network technology
5G fifth generation cellular network technology
802.x family of IEEE standards dealing with local area networks and metropolitan area networks
ABC alternative band classifier
ALF adaptive loop filter
APS adaptation parameter set
ASIC application specific integrated circuit
BD bit depth
BIF bilateral filter
BIF-chroma bilateral filter for chroma
BIF-luma bilateral filter for luma
BO band offset
Cb blue chrominance component
CCALF or CC-ALF cross-component ALF
CCSAO cross-component SAO
CDMA code-division multiple access
CMP cube-map projection
CPE customer premises equipment
Cr red chrominance component
CTB coding tree block
CTU coding tree unit
CU coding unit
DBF deblocking filter
DCT discrete cosine transform
DSP digital signal processor
ECM enhanced compression model
EO edge offset
FDMA frequency division multiple access
FPGA field programmable gate array
GDR gradual decoding refresh
GSM global system for mobile communications
H.222.0 MPEG-2 systems, standard for the generic coding of moving pictures and associated audio information
H.26x family of video coding standards in the domain of the ITU-T
HMD head mounted display
IBC intra block copy
id or ID identifier
IEC International Electrotechnical Commission
IEEE Institute of Electrical and Electronics Engineers
I/F interface
IMD integrated messaging device
IMS instant messaging service
I/O input output
IOT internet of things
IP internet protocol
ISO International Organization for Standardization
ISOBMFF ISO base media file format
ITU International Telecommunication Union
ITU-T ITU Telecommunication Standardization Sector
JTC joint technical committee
JVET joint video experts team
LEE laptop embedded equipment
LME laptop-mounted equipment
LTE long-term evolution
ML machine learning
MMS multimedia messaging service
MPEG moving picture experts group
MPEG-2 H.222/H.262 as defined by the ITU
MSE mean squared error
MV multiple views
NAL network abstraction layer
NN neural network
N/W network
PC personal computer
PDA personal digital assistant
PID packet identifier
PLC power line communication
QP quantization parameter or quarter pixel
RAM random access memory
RFID radio frequency identification
RFM reference frame memory
ROM read-only memory
Rx receiver
SAO sample adaptive offset
SMS short messaging service
SPS sequence parameter set
TCP-IP transmission control protocol-internet protocol
TDMA time divisional multiple access
TS transport stream
TV television
Tx transmitter
U blue projection of a chrominance component
UICC universal integrated circuit card
UMTS universal mobile telecommunications system
USB universal serial bus
V red projection of a chrominance component
VB virtual boundary
V2X vehicle-to-everything
VOIP voice over IP
VVC versatile video coding
WLAN wireless local area network
Y luminance component

### DETAILED DESCRIPTION OF EXAMPLE EMBODIMENTS

Described herein is a practical approach regarding video coding in relation to virtual boundaries. The models described herein may be used to perform any task, such as data compression, data decompression, video compression, video decompression, image or video classification, object classification, object detection, object tracking, speech recognition, language translation, music transcription, etc.

Versatile video coding (VVC) is a new international video coding standard and enhanced compression model (ECM), built on top of VVC, is potentially a new video coding standard that is currently under the development sponsored by joint video experts team (JVET). Both VVC and ECM support the functionality of gradual decoding refresh (GDR), which is mainly for low-latency controlled complexity (LLCC) video applications. With the current GDR design in VVC/ECM, an initial refreshed area starts on the left of a GDR picture and gradually expends over the associated recovering pictures. The most meaningful content information of a video sequence, however, may not necessarily always be in the left part of pictures. With features as described herein, a flexible GDR may be provided where an initial refreshed area can be in any location in a GDR picture.

In both VVC and ECM, a coded video sequence may consist of intra coded pictures and inter coded pictures. Intra coded pictures usually use many more bits than inter coded pictures. Transmission time of such big intra coded pictures increases the encoder to decoder delay. Gradual decoding refresh (GDR) alleviates the delay issue with intra coded pictures. Instead of coding an intra picture, GDR progressively refreshes pictures over several pictures.

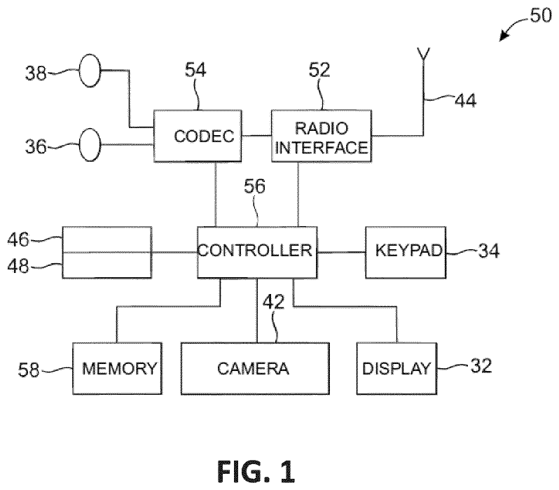

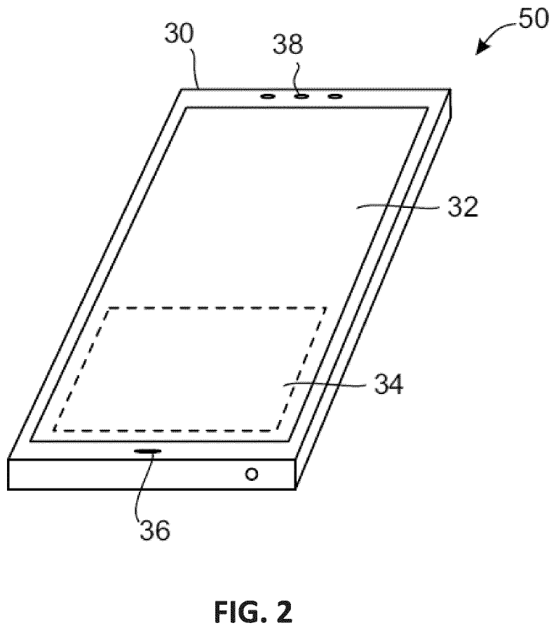

The following describes in detail a suitable apparatus and possible mechanisms to implement aspects of asymmetric in-loop filters at virtual boundaries. In this regard reference is first made to FIG. 1 and FIG. 2, where FIG. 1 shows an example block diagram of an apparatus 50. The apparatus may be an Internet of Things (IoT) apparatus configured to perform various functions, such as for example, gathering information by one or more sensors, receiving or transmitting information, analyzing information gathered or received by the apparatus, or the like. The apparatus may comprise a neural network weight update coding system, which may incorporate a codec. FIG. 2 shows a layout of an apparatus according to an example embodiment. The elements of FIG. 1 and FIG. 2 are explained next.

The electronic device 50 may for example be a mobile terminal or user equipment of a wireless communication system, a sensor device, a tag, or other lower power device. Alternatively, the electronic device may be a computer or part of a computer that is not mobile. However, it would be appreciated that embodiments of the examples described herein may be implemented within any electronic device or apparatus which may process data.

The apparatus 50 may comprise a housing 30 for incorporating and protecting the device. The apparatus 50 further may comprise a display 32 in the form of a liquid crystal display. In other embodiments of the examples described herein the display may be any suitable display technology suitable to display an image or video. The apparatus 50 may further comprise a keypad 34 (or touch area 34). In other embodiments of the examples described herein any suitable data or user interface mechanism may be employed. For example the user interface may be implemented as a virtual keyboard or data entry system as part of a touch-sensitive display.

The apparatus may comprise a microphone 36 or any suitable audio input which may be a digital or analog signal input. The apparatus 50 may further comprise an audio output device which in embodiments of the examples described herein may be any one of: an earpiece 38, speaker, or an analog audio or digital audio output connection. The apparatus 50 may also comprise a battery (or in other embodiments of the examples described herein the device may be powered by any suitable mobile energy device such as solar cell, fuel cell or clockwork generator). The apparatus may further comprise a camera 42 capable of recording or capturing images and/or video. The apparatus 50 may further comprise an infrared port for short range line of sight communication to other devices. In other embodiments the apparatus 50 may further comprise any suitable short range communication solution such as for example a Bluetooth wireless connection or a USB/firewire wired connection.

The apparatus 50 may comprise a controller 56, processor or processor circuitry for controlling the apparatus 50. The controller 56 may be connected to memory 58 which in embodiments of the examples described herein may store both data in the form of image and audio data and/or may also store instructions for implementation on the controller 56. The controller 56 may further be connected to codec circuitry 54 suitable for carrying out coding/compression of neural network weight updates and/or decoding of audio and/or video data or assisting in coding and/or decoding carried out by the controller.

The apparatus 50 may further comprise a card reader 48 and a smart card 46, for example a UICC and UICC reader for providing user information and being suitable for providing authentication information for authentication and authorization of the user at a network.

The apparatus 50 may comprise radio interface circuitry 52 connected to the controller and suitable for generating wireless communication signals for example for communication with a cellular communications network, a wireless communications system or a wireless local area network. The apparatus 50 may further comprise an antenna 44 connected to the radio interface circuitry 52 for transmitting radio frequency signals generated at the radio interface circuitry 52 to other apparatus(es) such as a network node, and/or for receiving radio frequency signals from other apparatus(es).

The apparatus 50 may comprise a camera capable of recording or detecting individual frames which are then passed to the codec 54 or the controller for processing. The apparatus may receive the video image data or machine learning data for processing from another device prior to transmission and/or storage. The apparatus 50 may also receive either wirelessly or by a wired connection the image for coding/decoding. The structural elements of apparatus 50 described above represent examples of means for performing a corresponding function.

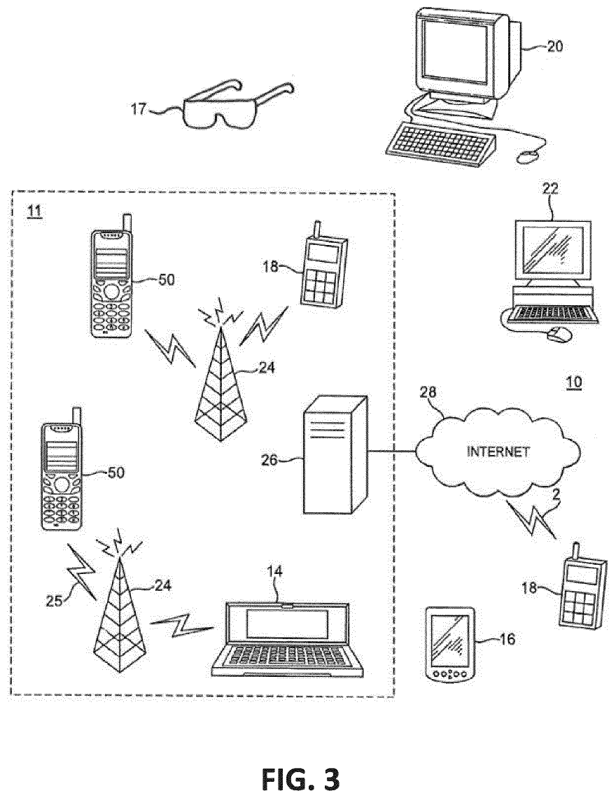

With respect to FIG. 3, an example of a system within which embodiments of the examples described herein can be utilized is shown. The system 10 comprises multiple communication devices which can communicate through one or more networks. The system 10 may comprise any combination of wired or wireless networks including, but not limited to a wireless cellular telephone network (such as a GSM, UMTS, CDMA, LTE, 4G, 5G network etc.), a wireless local area network (WLAN) such as defined by any of the IEEE 802.x standards, a Bluetooth personal area network, an Ethernet local area network, a token ring local area network, a wide area network, and the Internet.

The system 10 may include both wired and wireless communication devices and/or apparatus 50 suitable for implementing embodiments of the examples described herein.

For example, the system shown in FIG. 3 shows a mobile telephone network 11 and a representation of the internet 28, which is accessible to the various devices shown in FIG. 3 using communication link 2 (wired or wireless). Connectivity to the internet 28 may include, but is not limited to, long range wireless connections, short range wireless connections, and various wired connections including, but not limited to, telephone lines, cable lines, power lines, and similar communication pathways.

The example communication devices shown in the system 10 may include, but are not limited to, an electronic device or apparatus 50, a combination of a personal digital assistant (PDA) and a mobile telephone 14, a PDA 16, an integrated messaging device (IMD) 18, a desktop computer 20, a notebook computer 22. The apparatus 50 may be stationary or mobile when carried by an individual who is moving. The apparatus 50 may also be located in a mode of transport including, but not limited to, a car, a truck, a taxi, a bus, a train, a boat, an airplane, a bicycle, a motorcycle or any similar suitable mode of transport, or a head mounted display (HMD) 17.

The embodiments may also be implemented in a set-top box; i.e. a digital TV receiver, which may/may not have a display or wireless capabilities, in tablets or (laptop) personal computers (PC), which have hardware and/or software to process neural network data, in various operating systems, and in chipsets, processors, DSPs and/or embedded systems offering hardware/software based coding.

Some or further apparatus may send and receive calls and messages and communicate with service providers through a wireless connection 25 to a base station 24. The base station 24 may be connected to a network server 26 that allows communication between the mobile telephone network 11 and the internet 28. The system may include additional communication devices and communication devices of various types.

The communication devices may communicate using various transmission technologies including, but not limited to, code division multiple access (CDMA), global systems for mobile communications (GSM), universal mobile telecommunications system (UMTS), time divisional multiple access (TDMA), frequency division multiple access (FDMA), transmission control protocol-internet protocol (TCP-IP), short messaging service (SMS), multimedia messaging service (MMS), email, instant messaging service (IMS), Bluetooth, IEEE 802.11, 3GPP Narrowband IoT and any similar wireless communication technology. A communications device involved in implementing various embodiments of the examples described herein may communicate using various media including, but not limited to, radio, infrared, laser, cable connections, and any suitable connection.

In telecommunications and data networks, a channel may refer either to a physical channel or to a logical channel. A physical channel may refer to a physical transmission medium such as a wire, whereas a logical channel may refer to a logical connection over a multiplexed medium, capable of conveying several logical channels. A channel may be used for conveying an information signal, for example a bitstream, from one or several senders (or transmitters) to one or several receivers.

The embodiments may also be implemented in so-called IoT devices. The Internet of Things (IoT) may be defined, for example, as an interconnection of uniquely identifiable embedded computing devices within the existing Internet infrastructure. The convergence of various technologies has and may enable many fields of embedded systems, such as wireless sensor networks, control systems, home/building automation, etc. to be included in the Internet of Things (IoT). In order to utilize the Internet IoT devices are provided with an IP address as a unique identifier. IoT devices may be provided with a radio transmitter, such as a WLAN or Bluetooth transmitter or a RFID tag. Alternatively, IoT devices may have access to an IP-based network via a wired network, such as an Ethernet-based network or a power-line connection (PLC).

One application where asymmetric in-loop filters at virtual boundaries and model level update skipping in compressed incremental learning is important, is the use case of neural network based codecs, such as neural network based video codecs. Video codecs may use one or more neural networks. In a first case, the video codec may be a conventional video codec such as the Versatile Video Codec (VVC/H.266) that has been modified to include one or more neural networks. Examples of these neural networks are:
1. a neural network filter to be used as one of the in-loop filters of VVC
2. a neural network filter to replace one or more of the in-loop filter(s) of VVC
3. a neural network filter to be used as a post-processing filter
4. a neural network to be used for performing intra-frame prediction
5. a neural network to be used for performing inter-frame prediction.

In a second case, which is usually referred to as an end-to-end learned video codec, the video codec may comprise a neural network that transforms the input data into a more compressible representation. The new representation may be quantized, lossless compressed, then lossless decompressed, dequantized, and then another neural network may transform its input into reconstructed or decoded data.

In both of the above two cases, there may be one or more neural networks at the decoder-side, and consider the example of one neural network filter. The encoder may finetune the neural network filter by using the ground-truth data which is available at encoder side (the uncompressed data). Finetuning may be performed in order to improve the neural network filter when applied to the current input data, such as to one or more video frames. Finetuning may comprise running one or more optimization iterations on some or all the learnable weights of the neural network filter. An optimization iteration may comprise computing gradients of a loss function with respect to some or all the learnable weights of the neural network filter, for example by using the backpropagation algorithm, and then updating the some or all learnable weights by using an optimizer, such as the stochastic gradient descent optimizer. The loss function may comprise one or more loss terms. One example loss term may be the mean squared error (MSE). Other distortion metrics may be used as the loss terms. The loss function may be computed by providing one or more data to the input of the neural network filter, obtaining one or more corresponding outputs from the neural network filter, and computing a loss term by using the one or more outputs from the neural network filter and one or more ground-truth data. The difference between the weights of the finetuned neural network and the weights of the neural network before finetuning is referred to as the weight-update. This weight-update needs to be encoded, provided to the decoder side together with the encoded video data, and used at the decoder side for updating the neural network filter. The updated neural network filter is then used as part of the video decoding process or as part of the video post-processing process. It is desirable to encode the weight-update such that it requires a small number of bits. Thus, the examples described herein consider also this use case of neural network based codecs as a potential application of the compression of weight-updates.

A video codec consists of an encoder that transforms the input video into a compressed representation suited for storage/transmission and a decoder that can decompress the compressed video representation back into a viewable form. A video encoder and/or a video decoder may also be separate from each other, i.e. need not form a codec. Typically the encoder discards some information in the original video sequence in order to represent the video in a more compact form (that is, at lower bitrate).

Typical hybrid video encoders, for example many encoder implementations of ITU-T H.263 and H.264, encode the video information in two phases. Firstly pixel values in a certain picture area (or “block”) are predicted for example by motion compensation means (finding and indicating an area in one of the previously coded video frames that corresponds closely to the block being coded) or by spatial means (using the pixel values around the block to be coded in a specified manner). Secondly the prediction error, i.e. the difference between the predicted block of pixels and the original block of pixels, is coded. This is typically done by transforming the difference in pixel values using a specified transform (e.g. Discrete Cosine Transform (DCT) or a variant of it), quantizing the coefficients and entropy coding the quantized coefficients. By varying the fidelity of the quantization process, encoder can control the balance between the accuracy of the pixel representation (picture quality) and size of the resulting coded video representation (file size or transmission bitrate).

In temporal prediction, the sources of prediction are previously decoded pictures (a.k.a. reference pictures). In intra block copy (IBC; a.k.a. intra-block-copy prediction and current picture referencing), prediction is applied similarly to temporal prediction but the reference picture is the current picture and only previously decoded samples can be referred in the prediction process. Inter-layer or inter-view prediction may be applied similarly to temporal prediction, but the reference picture is a decoded picture from another scalable layer or from another view, respectively. In some cases, inter prediction may refer to temporal prediction only, while in other cases inter prediction may refer collectively to temporal prediction and any of intra block copy, inter-layer prediction, and inter-view prediction provided that they are performed with the same or similar process as temporal prediction. Inter prediction or temporal prediction may sometimes be referred to as motion compensation or motion-compensated prediction.

Inter prediction, which may also be referred to as temporal prediction, motion compensation, or motion-compensated prediction, reduces temporal redundancy. In inter prediction the sources of prediction are previously decoded pictures. Intra prediction utilizes the fact that adjacent pixels within the same picture are likely to be correlated. Intra prediction can be performed in the spatial or transform domain, i.e., either sample values or transform coefficients can be predicted. Intra prediction is typically exploited in intra coding, where no inter prediction is applied.

One outcome of the coding procedure is a set of coding parameters, such as motion vectors and quantized transform coefficients. Many parameters can be entropy-coded more efficiently if they are predicted first from spatially or temporally neighboring parameters. For example, a motion vector may be predicted from spatially adjacent motion vectors and only the difference relative to the motion vector predictor may be coded. Prediction of coding parameters and intra prediction may be collectively referred to as in-picture prediction.

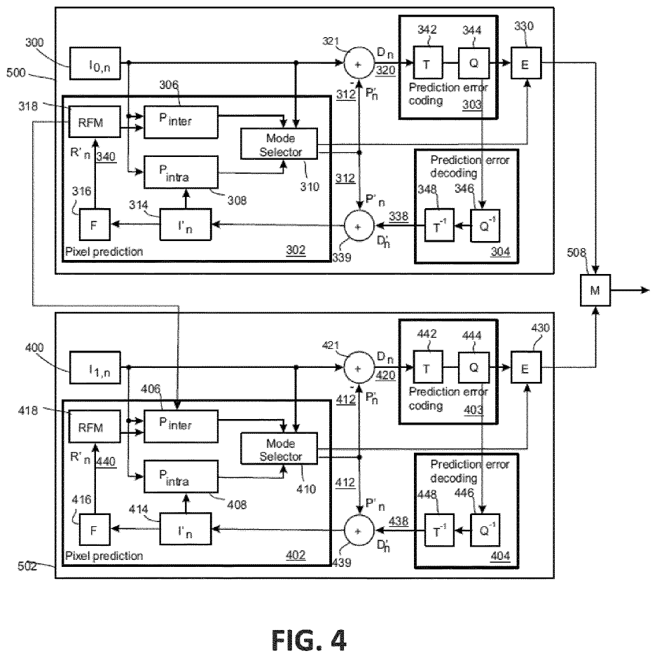

FIG. 4 shows a block diagram of a general structure of a video encoder. FIG. 4 presents an encoder for two layers, but it would be appreciated that presented encoder could be similarly extended to encode more than two layers. FIG. 4 illustrates a video encoder comprising a first encoder section 500 for a base layer and a second encoder section 502 for an enhancement layer. Each of the first encoder section 500 and the second encoder section 502 may comprise similar elements for encoding incoming pictures. The encoder sections 500, 502 may comprise a pixel predictor 302, 402, prediction error encoder 303, 403 and prediction error decoder 304, 404. FIG. 4 also shows an embodiment of the pixel predictor 302, 402 as comprising an inter-predictor 306, 406 (Pᵢₙₜₑᵣ), an intra-predictor 308, 408 (Pᵢₙₜᵣₐ), a mode selector 310, 410, a filter 316, 416 (F), and a reference frame memory 318, 418 (RFM). The pixel predictor 302 of the first encoder section 500 receives 300 base layer images (I_{0,n}) of a video stream to be encoded at both the inter-predictor 306 (which determines the difference between the image and a motion compensated reference frame 318) and the intra-predictor 308 (which determines a prediction for an image block based only on the already processed parts of the current frame or picture). The output of both the inter-predictor and the intra-predictor are passed to the mode selector 310. The intra-predictor 308 may have more than one intra-prediction modes. Hence, each mode may perform the intra-prediction and provide the predicted signal to the mode selector 310. The mode selector 310 also receives a copy of the base layer picture 300. Correspondingly, the pixel predictor 402 of the second encoder section 502 receives 400 enhancement layer images (I_{1,n}) of a video stream to be encoded at both the inter-predictor 406 (which determines the difference between the image and a motion compensated reference frame 418) and the intra-predictor 408 (which determines a prediction for an image block based only on the already processed parts of the current frame or picture). The output of both the inter-predictor and the intra-predictor are passed to the mode selector 410. The intra-predictor 408 may have more than one intra-prediction modes. Hence, each mode may perform the intra-prediction and provide the predicted signal to the mode selector 410. The mode selector 410 also receives a copy of the enhancement layer picture 400.

Depending on which encoding mode is selected to encode the current block, the output of the inter-predictor 306, 406 or the output of one of the optional intra-predictor modes or the output of a surface encoder within the mode selector is passed to the output of the mode selector 310, 410. The output of the mode selector is passed to a first summing device 321, 421. The first summing device may subtract the output of the pixel predictor 302, 402 from the base layer picture 300/enhancement layer picture 400 to produce a first prediction error signal 320, 420 (Dₙ) which is input to the prediction error encoder 303, 403.

The pixel predictor 302, 402 further receives from a preliminary reconstructor 339, 439 the combination of the prediction representation of the image block 312, 412 (P′ₙ) and the output 338, 438 (D′ₙ) of the prediction error decoder 304, 404. The preliminary reconstructed image 314, 414 (I′ₙ) may be passed to the intra-predictor 308, 408 and to the filter 316, 416. The filter 316, 416 receiving the preliminary representation may filter the preliminary representation and output a final reconstructed image 340, 440 (R′n) which may be saved in a reference frame memory 318, 418. The reference frame memory 318 may be connected to the inter-predictor 306 to be used as the reference image against which a future base layer picture 300 is compared in inter-prediction operations. Subject to the base layer being selected and indicated to be the source for inter-layer sample prediction and/or inter-layer motion information prediction of the enhancement layer according to some embodiments, the reference frame memory 318 may also be connected to the inter-predictor 406 to be used as the reference image against which a future enhancement layer picture 400 is compared in inter-prediction operations. Moreover, the reference frame memory 418 may be connected to the inter-predictor 406 to be used as the reference image against which a future enhancement layer picture 400 is compared in inter-prediction operations.

Filtering parameters from the filter 316 of the first encoder section 500 may be provided to the second encoder section 502 subject to the base layer being selected and indicated to be the source for predicting the filtering parameters of the enhancement layer according to some embodiments.

The prediction error encoder 303, 403 comprises a transform unit 342, 442 (T) and a quantizer 344, 444 (Q). The transform unit 342, 442 transforms the first prediction error signal 320, 420 to a transform domain. The transform is, for example, the DCT transform. The quantizer 344, 444 quantizes the transform domain signal, e.g. the DCT coefficients, to form quantized coefficients.

The prediction error decoder 304, 404 receives the output from the prediction error encoder 303, 403 and performs the opposite processes of the prediction error encoder 303, 403 to produce a decoded prediction error signal 338, 438 which, when combined with the prediction representation of the image block 312, 412 at the second summing device 339, 439, produces the preliminary reconstructed image 314, 414. The prediction error decoder 304, 404 may be considered to comprise a dequantizer 346, 446 (Q⁻¹), which dequantizes the quantized coefficient values, e.g. DCT coefficients, to reconstruct the transform signal and an inverse transformation unit 348, 448 (T⁻¹), which performs the inverse transformation to the reconstructed transform signal wherein the output of the inverse transformation unit 348, 448 contains reconstructed block(s). The prediction error decoder may also comprise a block filter which may filter the reconstructed block(s) according to further decoded information and filter parameters.

The entropy encoder 330, 430 (E) receives the output of the prediction error encoder 303, 403 and may perform a suitable entropy encoding/variable length encoding on the signal to provide error detection and correction capability. The outputs of the entropy encoders 330, 430 may be inserted into a bitstream e.g. by a multiplexer 508 (M).

The concept of virtual boundaries was introduced in VVC. A picture may be divided into different regions by virtual boundaries from a coding dependency perspective. For example, 360°: virtual boundaries are used to define the boundaries of different faces of a 360° picture in CMP format, and GDR (with reference to U.S. provisional application No. 63/296,590, “New Gradual Decoding Refresh for ECM”, filed by Applicant of this disclosure), where a virtual boundary separates the refreshed area and non-refreshed area of a GDR/recovering picture. In VVC, virtual boundaries are specified in a SPS and/or a picture header.

There are three in-loop filters in VVC. They are deblocking, SAO and ALF. ECM enhances the in-loop filters with new features, including Bilateral (JVET-F0034, JVET-V0094), BIF for chroma (JVET-X0067), CCSAO (JVET-V0153, JVET-Y0106), CCALF (JVET-X0045), and Alternative band classifier for ALF (JVET-X0070).

In-loop filtering of a current pixel often requires use of coding information of its neighbors. Hence, filtering on one side of a virtual boundary may involve use of coding information on other side of the virtual boundary.

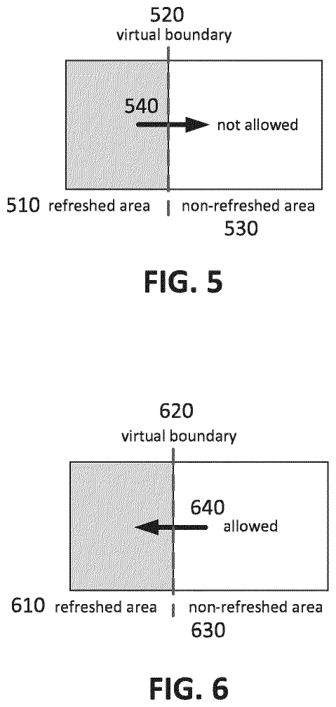

For some applications, it may not be allowed to have in-loop filtering cross a virtual boundary. For example, in GDR, a GDR/recovering picture may be divided into a refreshed area and a non-refreshed area by a virtual boundary. Referring to FIG. 5, to avoid leaks, the refreshed area 510 cannot use any information of non-refreshed area 530, because there is no guarantee that the non-refreshed area 530 is decoded correctly at the decoder. Incorrectly decoded coding information may contaminate the refreshed area 510, which may result in leaks or mismatch of the encoder and decoder at recovery point pictures and successive pictures. Hence, for a GDR/recovering picture, in-loop filtering cannot cross the virtual boundary 520 from refreshed area 510 to non-refreshed area 530, as indicated by the arrow 540.

On the other hand, sometimes it is perfectly fine to let in-loop filtering cross a virtual boundary. For example, as shown in FIG. 6, in the same example of GDR, the non-refreshed area 630 can use information of refreshed area 610. Hence, for a GDR/recovering picture, in-loop filtering can cross the virtual boundary 620 from non-refreshed area 630 to refreshed area 610, as indicated by the arrow 640.

In the current designs of VVC and ECM, in-loop filtering cannot cross virtual boundaries.

U.S. provisional application No. 63/362,243, “In-Loop Filtering at Virtual Boundaries”, filed by Applicant of this disclosure and which is hereby incorporated by reference in its entirety, proposed several possible options of in-loop filtering at virtual boundaries. Among them is asymmetric in-loop filtering at a virtual boundary. With this asymmetric option, in-loop filtering cannot cross a virtual boundary from one side of the virtual boundary to the other side of the virtual boundary, but can from the other side to the one side.

Specifically, in-loop filtering of one side of a virtual boundary cannot use information of the other side of the virtual boundary, but in-loop filtering of the other side of the virtual boundary can use information of the one side. If in-loop filtering for a pixel in the one side of the virtual boundary requires use of any information (e.g. pixels, coding mode, QP, etc.) of the other side, in-loop filtering is either not performed for the pixel or still performed for the pixel but with padding the information of the other side.

With asymmetric in-loop filtering at a virtual boundary, in-loop filtering of one side cannot use information of other side, but in-loop filtering of the other side is allowed to use information of the one side.

In-loop filtering of a pixel in the one side may not be performed normally if in-loop filtering of the pixel requires use of coding information of the other side.

In general, in-loop filtering of a pixel in the other side can be performed normally because in-loop filtering of the pixel is allowed to use the coding information of both the one side and the other side. But, the other side may choose not to use the coding information of the one side, in which case, in-loop filtering of a pixel in the other side may not be performed normally if in-loop filtering of the pixel requires use of coding information of the one side.

Since the coding information of the one side is available for the other side, an offset based upon in-loop filtering of the one side may be added to the output of in-loop filtering of the other side.

A virtual boundary is a line, that is used to separate a picture, or a portion of a picture, into two areas; a first area and a second area.

A virtual boundary can be vertical or horizontal. In VVC and ECM, virtual boundary syntax is included in the SPS and/or picture header. In one embodiment, such as with asymmetric operation at a virtual boundary, the first area is not allowed to use any information of the second area, but the second area can use the information of the first area.

In one embodiment, in a GDR/recovering picture, the first area is a clean (refreshed) area and the second area is a dirty (non-refreshed) area. The clean (refreshed) area cannot use any information of the dirty (non-refreshed) area, but the dirty (non-refreshed) area can use information of the clean (refreshed) area. In-loop filtering for a pixel may involve in use of coding information of its neighbors.

If in-loop filtering of a pixel in the first area requires use of coding information (e.g. pixels, coding mode, reference picture, MV, QP, etc.) of the second area, in-loop filtering of the pixel may not be performed normally. Actual in-loop filtering for the pixel may take one of two possible options, option 1 where in-loop filtering for the pixel in the first area is not performed, or option 2 where in-loop filtering for the pixel in the first area is still performed, but with the coding information of the second area derived from the first area, or set to pre-determined values, when needed.

One embodiment related to option 2 is that if in-loop filtering of a pixel in the first area requires use of pixels in the second area, the pixels in the second area are padded from the pixels in the first area.

Another embodiment related to option 2 is that if in-loop filtering of a pixel in the first area requires use of pixels in the second area, the pixels in the second area are replaced by the pixels extrapolated from the first area.

Let normal in-loop filtering of a pixel be ideal in-loop filtering of the pixel with using all the necessary information, and actual in-loop filtering of a pixel be practical in-loop filtering of the pixel with or without using all the necessary information.

Actual in-loop filtering of a pixel in either option 1 or 2 generates an output that may be different from the normal in-loop filtering of the pixel which can use the coding information of both the first area and the second area.

In-loop filtering for pixels in the second area can generally be performed normally because in-loop filtering for pixels in the second area is allowed to use the coding information of both the first area and the second area.

In one embodiment, the second area may choose not to use the coding information of the first area. In that case, if in-loop filtering of a pixel in the second area requires use of coding information of the first area, in-loop filtering of the pixel may not be performed normally. Similar to the first area, actual in-loop filtering for the pixel may take one of two possible options, option 1 where in-loop filtering for the pixel in the second area is not performed, or option 2 where in-loop filtering for the pixel in the second area is still performed, but with the coding information of the first area derived from the second area, or set to pre-determined values, when needed.

One embodiment related to the above option 2 is that if in-loop filtering of a pixel in the second area requires use of pixels in the first area, the pixels in the first area are padded from the pixels in the second area.

Another embodiment related to the above option 2 is that if in-loop filtering of a pixel in the second area requires use of pixels in the first area, the pixels in the first area are replaced by the pixels extrapolated from the second area.

In one embodiment, if the first area and the second area choose the same option for in-loop filtering of pixels around virtual boundaries, that is either not perform in-loop filtering or perform it with padding, in-loop filtering of the first area and the second area may be deemed as balanced. Compensation may not be needed on either side of a virtual boundary.

One embodiment is related to a deblocking filter in VVC and ECM. Deblocking filtering is applied to a (horizontal or vertical) block boundary, involving pixels on both sides of the block boundary.

Assume a virtual boundary separates a picture or a portion of a picture into a first area and a second area, and the first area is not allowed to use coding information in the second area, but the second area can use coding information in the first area.

If the block boundary is aligned with the virtual boundary, deblocking filtering for pixels in the first area up to n (e.g. 1 for chroma weak filter, 2 for luma weak filter, 3 for luma and chroma strong filters, 3, 5, 7 for luma bilinear (long) filters in the current design of VVC and ECM) pixel positions away from the virtual boundary requires use of coding information (e.g. pixels, coding mode, QP, etc.) in the second area.

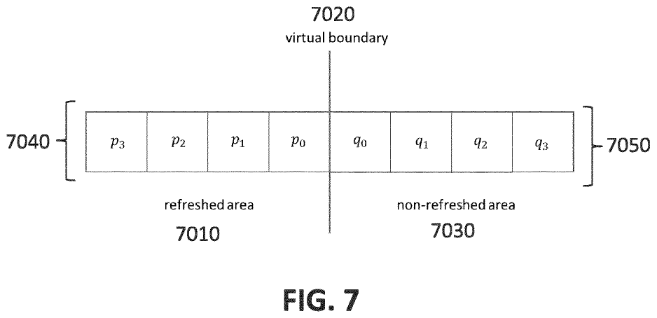

Since the first area is not allowed to use coding information in the second area, deblocking filtering is disabled for those pixels in the first area up to n pixel positions away from the virtual boundary. FIG. 7 shows an example where the refreshed area (the first area) 7010 of a GDR/recovering picture is not allowed to use coding information of non-refreshed area (the second area) 7030. Deblocking (e.g. strong filter) 7040 is disabled for pixels, pᵢ, i=0, 1, 2, in the refreshed area 7010 next to the virtual boundary 7020.

Alternatively, deblocking filtering 7040 is still applied to those pixels in the first area up to n pixel positions away from the virtual boundary 7020, but with the coding information in the second area derived from the first area or set to pre-determined values, when needed. For example, in FIG. 7, deblocking (e.g. strong filter) is still applied to pixels (generally 7040), pᵢ, i=0, 1, 2, in the refreshed area 7010 next to the virtual boundary 7020, but with the associated pixels 7050, including qᵢ, i=0, 1, 2, in the non-refreshed area 7030 derived from the refreshed area 7010. For example, qᵢ, i=0, 1, 2, may be set to be equal to p₀, or the mean or the median of pᵢ, i=0, 1, 2.

Deblocking for pixels on the second area can be performed normally with being allowed to use the coding information of both the first area 7010 and the second area 7030.

If actual deblocking filtering of a pixel pᵢ in the first area 7010 is different from the normal deblocking filtering, the difference can be offset from a corresponding pixel qᵢ as

$${\hat{q}}_{i}^{′} = {\hat{q}}_{i} - {\sum }_{j} {w}_{i , j} ( {\hat{p}}_{j} - {\tilde{p}}_{j} )$$

where \hat{q}ᵢ′ is the final output of deblocking filtering of qᵢ, \hat{q}ᵢ is the output of deblocking filtering of qᵢ, \hat{p}ᵢ is the output of normal deblocking filtering of pᵢ with using all the necessary information including information of the first area 7010 and/or the second area 7030, \tilde{p}ᵢ is the output of actual deblocking filtering of pᵢ, w_{i,j} is the weight for the contribution of (\hat{p}ⱼ−\tilde{p}ⱼ) to qᵢ, and i and j are pixel indices indicating the positions away from the virtual boundary (e.g. i=0 indicting the position just next to the virtual boundary).

One possible embodiment can be as follows,

$${\hat{q}}_{i}^{′} = {\hat{q}}_{i} - {\sum }_{j = 0}^{s p - 1} \frac{1}{{2}^{i + j}} ( {\hat{p}}_{j} - {\tilde{p}}_{j} ) for i = 0 , … , sq - 1$$

where sp and sq are filter lengths for pixels pᵢ in the first area and pixels qᵢ in the second area, respectively.

A simple embodiment can even be as follows,

$${\hat{q}}_{i}^{′} = {\hat{q}}_{i} - \frac{1}{{2}^{i}} ( {\hat{p}}_{i} - {\tilde{p}}_{i} ) .$$

The corresponding pixels pᵢ and qᵢ are the mirrored pixels in the first area 7010 and the second area 7030 before deblocking with respect to the block boundary or the virtual boundary 7020, as shown in FIG. 7.

If the second area 7030 chooses not to use coding information of the first area 7010, deblocking filtering is not applied to pixels in the second area 7030 up to n (e.g. 1 for chroma weak filter, 2 for luma weak filter, 3 for luma and chroma strong filters, 3, 5, 7 for luma bilinear (long) filters in the current design of VVC and ECM) pixel positions away from the virtual boundary. FIG. 7 may show an example where the non-refreshed area (the second area) 7030 of a GDR/recovering picture chooses not to use coding information of refreshed area (the first area) 7010. Deblocking (e.g. a strong filter) is disabled for pixels, qᵢ, i=0, 1, 2, in the non-refreshed area 7030 next to the virtual boundary 7020.

Alternatively, deblocking filtering is still applied to those pixels 7050 in the second area 7030 up to n pixel positions away from the virtual boundary 7020, but with the coding information in the first area 7010 derived from the second area 7030 or set to pre-determined values. For example, in FIG. 7, deblocking (e.g. a strong filter) may still be applied to pixels (generally 7050), qᵢ, i=0, 1, 2, in the non-refreshed area 7030 next to the virtual boundary 7020, but with the associated pixels 7040, including pᵢ, i=0, 1, 2, in the refreshed area 7010 derived from the non-refreshed area 7030. For example, pᵢ, i=0, 1, 2, may be set to be equal to q₀, or a mean or median of qᵢ, i=0, 1, 2.

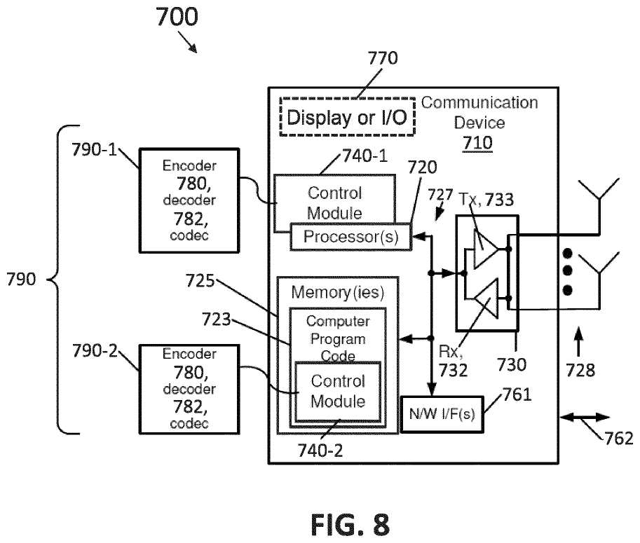

FIG. 8 is a block diagram 700 of an apparatus 710 suitable for implementing the example embodiments. One non-limiting example of the apparatus 710 is a wireless, typically mobile device that can access a wireless network. The apparatus 710 includes one or more processors 720, one or more memories 725, one or more transceivers 730, and one or more network (N/W) interfaces (I/F(s)) 761, interconnected through one or more buses 727. Each of the one or more transceivers 730 includes a receiver, Rx, 732 and a transmitter, Tx, 733. The one or more buses 727 may be address, data, or control buses, and may include any interconnection mechanism, such as a series of lines on a motherboard or integrated circuit, fiber optics or other optical communication equipment, and the like.

The apparatus 710 may communicate via wired, wireless, or both interfaces. For wireless communication, the one or more transceivers 730 are connected to one or more antennas 728. The one or more memories 725 include computer program code 723. The N/W I/F(s) 761 communicate via one or more wired links 762.

The apparatus 710 includes a control module 740, comprising one of or both parts 740-1 and/or 740-2, which include reference 790 that includes encoder 780, or decoder 782, or a codec of both 780/782, and which may be implemented in a number of ways. For ease of reference, reference 790 is referred to herein as a codec. The control module 740 may be implemented in hardware as control module 740-1, such as being implemented as part of the one or more processors 720. The control module 740-1 may be implemented also as an integrated circuit or through other hardware such as a programmable gate array. In another example, the control module 740 may be implemented as control module 740-2, which is implemented as computer program code 723 and is executed by the one or more processors 720. For instance, the one or more memories 725 and the computer program code 723 may be configured to, with the one or more processors 720, cause the user equipment 710 to perform one or more of the operations as described herein. The codec 790 may be similarly implemented as codec 790-1 as part of control module 740-1, or as codec 790-2 as part of control module 740-2, or both.

The computer readable memories 725 may be of any type suitable to the local technical environment and may be implemented using any suitable data storage technology, such as semiconductor-based memory devices, flash memory, firmware, magnetic memory devices and systems, optical memory devices and systems, fixed memory and removable memory. The computer readable memories 725 may be means for performing storage functions. The computer readable one or more memories 725 may be non-transitory, transitory, volatile (e.g. random access memory (RAM)) or non-volatile (e.g. read-only memory (ROM)). The computer readable one or more memories 725 may comprise a database for storing data.

The processors 720 may be of any type suitable to the local technical environment, and may include one or more of general-purpose computers, special purpose computers, microprocessors, digital signal processors (DSPs) and processors based on a multi-core processor architecture, as non-limiting examples. The processors 720 may be means for performing functions, such as controlling the apparatus 710, and other functions as described herein.

In general, the various embodiments of the apparatus 710 can include, but are not limited to, cellular telephones (such as smart phones, mobile phones, cellular phones, voice over Internet Protocol (IP) (VOIP) phones, and/or wireless local loop phones), tablets, portable computers, room audio equipment, immersive audio equipment, vehicles or vehicle-mounted devices for, e.g., wireless V2X (vehicle-to-everything) communication, image capture devices such as digital cameras, gaming devices, music storage and playback appliances, Internet appliances (including Internet of Things, IoT, devices), IoT devices with sensors and/or actuators for, e.g., automation applications, as well as portable units or terminals that incorporate combinations of such functions, laptops, laptop-embedded equipment (LEE), laptop-mounted equipment (LME), Universal Serial Bus (USB) dongles, smart devices, wireless customer-premises equipment (CPE), an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain context), a consumer electronics device, a device operating on commercial and/or industrial wireless networks, and the like. That is, the apparatus 710 could be any device that may be capable of wireless or wired communication.

Thus, the apparatus 710 comprises a processor 720, at least one memory 725 including computer program code 723, wherein the at least one memory 725 and the computer program code 723 are configured to, with the at least one processor 720, cause the apparatus 710 to implement asymmetric in-loop filters 790 at virtual boundaries, based on the examples described herein. The apparatus 710 optionally includes a display or I/O 770 that may be used to display content during ML/task/machine/NN processing or rendering. Display or I/O 770 may be configured to receive input from a user, such as with a keypad, touchscreen, touch area, microphone, biometric recognition, one or more sensors, etc. Apparatus 710 may comprise standard well-known components such as an amplifier, filter, frequency-converter, and (de) modulator.

Computer program code 723 may comprise object oriented software, and may implement the filtering described throughout this disclosure. The apparatus 710 need not comprise each of the features mentioned, or may comprise other features as well. The apparatus 710 may be an embodiment of apparatuses shown in FIG. 1, FIG. 2, FIG. 3, or FIG. 4, including any combination of those.

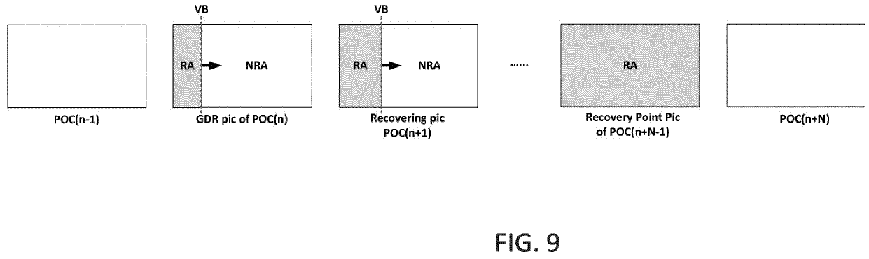

As noted above, in the current GDR design in VVC/ECM design, an initial refreshed area starts on the left of a GDR picture and then gradually expands to the right over the associated recovering pictures, as shown in FIG. 9. A virtual boundary specified in picture header is used to separate refreshed area and non-refreshed area of a GDR/recovering picture. Both encoder and decoder assume the left side of the virtual boundary is refreshed area and the right side is non-refreshed area. An example is shown in FIG. 9 where a refreshed area (RA) starts on the left side of a GDR picture and gradually expands to the right over the associated recovering pictures.

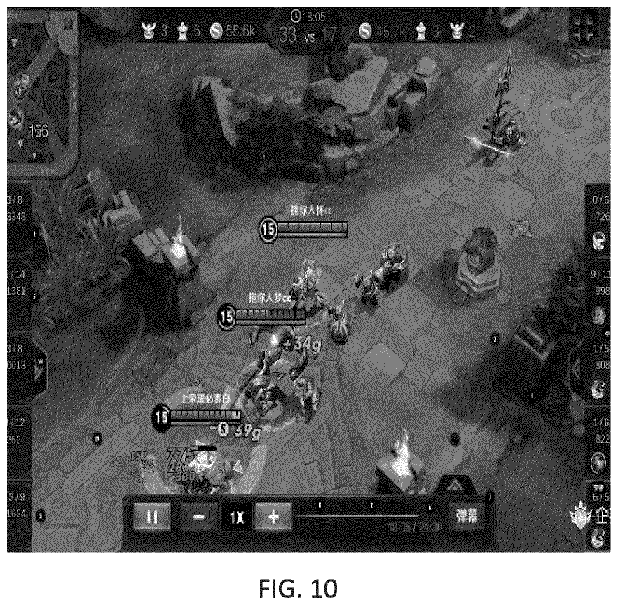

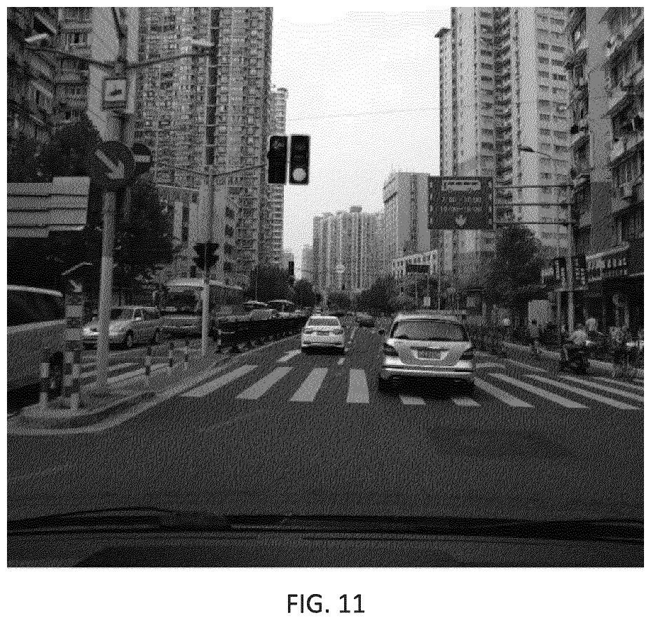

However, it has been observed that the most important content information of a video sequence may not necessarily always be in the left part of pictures. In fact, most of gaming sequences may have their main characters in the middle of pictures and many natural video sequences can have their major activities and motions occurring in any parts of pictures, as shown in FIGS. 10 and 11. Therefore, it is proposed herein to have an initial refreshed area cover a more meaningful area(s) of a sequence, instead of a fixed area (such as the left area as in the current VVC/ECM GDR designs). FIG. 10 shows a JVET test sequence for a gaming sequence regarding the game ARENA OF VALOR. FIG. 11 shows a JVET test sequence for a photograph of a road in daylight (DaylightRoad2) with a natural sequence. For both there are main characters and activities around the center area of pictures.

A flexible GDR is described in U.S. provisional patent application No. 63/480,085 filed on Jan. 16, 2023 by the same applicant as herein and which is hereby incorporated by reference in its entirety, where an initial refreshed area can be in any location of a GDR picture and then gradually expand over the associated recovering pictures.

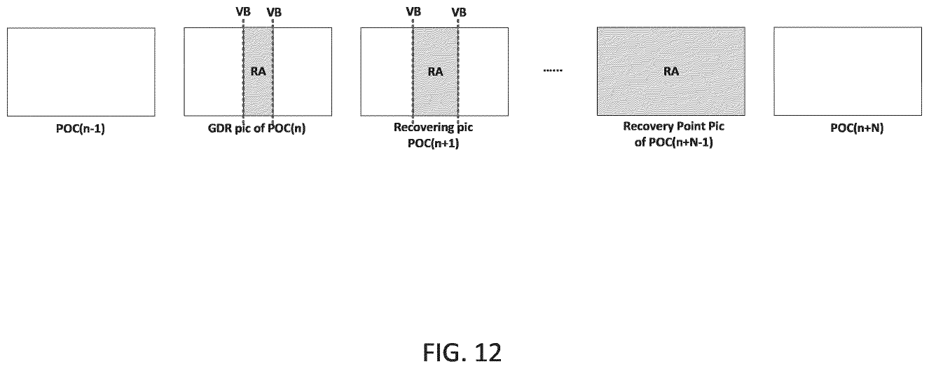

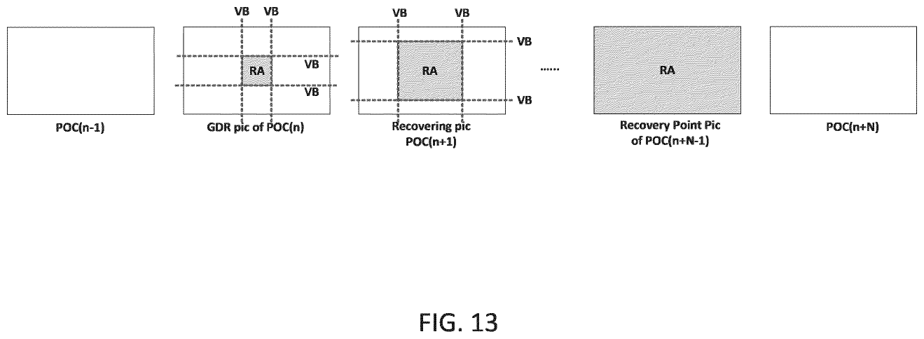

FIGS. 12 and 13 show two examples for a flexible GDR. In FIG. 12 an initial refreshed area (RA) is located in the middle of a GDR picture, and then gradually expands into a non-refreshed area to the left and the right sides of the associated recovering pictures. In FIG. 13 an initial refreshed area (RA) is in the center of a GDR picture, and then gradually expands in four directions into a non-refreshed area over the associated recovering pictures.

Features as described herein may be used to provide a flexible GDR. This flexible GDR may follow a same coding rule for the GDR designs in VVC/ECM, where coding units (CUs) in a refreshed area of a current GDR/recovering picture do not use any coding information of a non-refreshed areas of current picture and also do not use any coding information of a non-refreshed area(s) of reference picture. So, CUs in a refreshed area of the current picture cannot use the coding information of non-refreshed areas of reference pictures, but can use the coding information of refreshed areas of reference pictures. This helps to prevent leak from occurring. In both VVC and ECM, spatial and temporal prediction are used for coding CUs. However, it is very likely that a CU in refreshed area of a current picture may require use of the coding information in a non-refreshed area of the current picture and/or a non-refreshed area of a reference picture.

To prevent CUs in a refreshed area from using the coding information in non-refreshed areas, for the CUs in refreshed area of a current picture:
1. The values of pixels in non-refreshed areas of the current picture and/or reference pictures are:
   a. set to a predetermined value(s) (e.g. 2^{B-1}, where B is the bit depth), or
   b. replaced by the values derived from pixels in refreshed areas of the current picture and/or reference pictures.
2. A coding mode per block (such as 4×4 for example) in a non-refreshed area of the current picture and/or reference pictures are:
   a. treated as “not available”, or
   b. set to intra mode with pre-determined mode value(s) (such as zero “0” for example).

A description on how to replace the values of pixels in non-refreshed areas by the values derived from the pixels in refreshed areas (item 1 (b) above) are described in further detail below.

When deriving the pixels in non-refreshed areas from the pixels in refreshed areas, both the encoder and the decoder may follow the same rule(s).

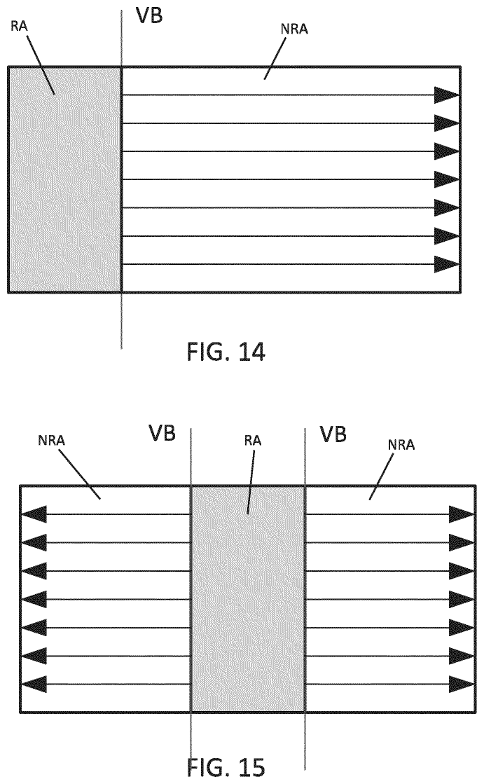

In a first example embodiment, for CUs in a refreshed area of a current picture, pixels in refreshed areas of the current picture and the associated reference pictures may be repeated into non-refreshed areas of the current picture and the associated reference pictures horizontally. The values of the pixels may be used to replace the values of the corresponding pixels in non-refreshed areas of the current picture and the associated reference pictures at both the encoder and the decoder. Thus, the values of the pixels in the refreshed areas may be used to replace the values of the corresponding pixels in the non-refreshed areas. FIG. 14 shows an example for GDR with a refreshed area starting from left, where a GDR/recovering picture is divided into refreshed area (RA) and non-refreshed area (NRA) by one virtual boundary (VB). In the example of FIG. 14, the right boundary pixels in the refreshed area are repeated into the non-refreshed area horizontally from left to right, as shown by the arrows.

FIG. 15 shows an example for GDR with a refreshed area starting in the middle, where a GDR/recovering picture is divided into a refreshed area (RA) and a non-refreshed area (NRA) by two (2) virtual boundaries (VB). In the example of FIG. 15, the left boundary pixels in the refreshed area are repeated leftward into the non-refreshed area horizontally from the right, and the right boundary pixels in the refreshed area are repeated into non-refreshed area horizontally from the left to the right, as shown by the arrows.

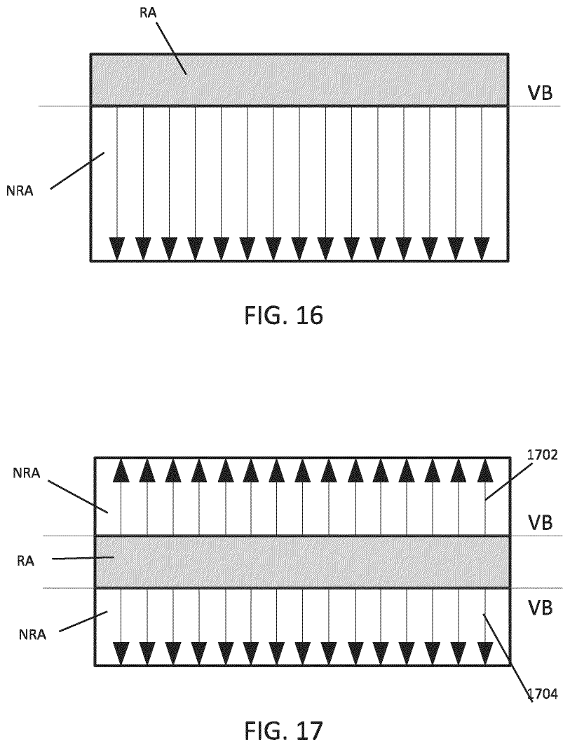

Referring also to FIG. 16, a second embodiment may be provided where, for CUs in the refreshed area (RA) of the current picture, pixels in refreshed areas of the current picture and the associated reference pictures may be repeated into the non-refreshed area of the current picture and the associated reference pictures vertically. The values of the pixels from the refreshed area may be used to replace the values of the corresponding pixels in non-refreshed areas of the current picture and the associated reference pictures at both the encoder and the decoder. Thus, the values of the pixels in the refreshed area may be used to replace the values of the corresponding pixels in non-refreshed areas. FIG. 16 shows an example for GDR with the refreshing starting from the above, where a GDR/recovering picture is divided into the refreshed area (RA) and the non-refreshed area (NRA) by one virtual boundary (VB). In the example of FIG. 16, the lower boundary pixels in the refreshed area are repeated into the non-refreshed area (NRA) vertically from above, as shown by the arrows.

FIG. 17 shows an example for GDR with a refreshed area starting in the middle, where a GDR/recovering picture is divided into the refreshed area (RA) and non-refreshed area (NRA) by two virtual boundaries (VB). In the example of FIG. 17, the upper boundary pixels in the refreshed area are repeated into the non-refreshed area vertically upward from below as shown by arrows 1702, and the lower boundary pixels in the refreshed area are repeated into the non-refreshed area vertically downward from above as shown by the arrows 1704.

There are cases where only repeating pixels horizontally or alternatively only repeating pixels vertically, from the refreshed area(s) into the non-refreshed area(s), will not be able to cover all the pixels in one or more non-refreshed areas. For example, for the GDR with a refreshed area which has both a different width and a different height as the picture, neither horizontally repeating of pixels alone nor vertically repeating of pixels alone from the refreshed area into the non-refreshed area will be able to cover all the non-refreshed area pixels. Thus, if both the horizontal-to-horizontal size of the refresh area to the non-refresh area (or the picture or portion of the picture) is different, and the vertical-to-vertical size of the refresh area to the non-refresh area (or the picture or portion of the picture) is different, use of the methods shown in FIGS. 14-17 will not be sufficient to cover all of the pixels in one or more non-refreshed areas. In other words, if both the horizontal size of the refresh area to the horizontal size of the non-refresh area (or the picture or portion of the picture) is different, and the vertical-size of the refresh area to the vertical size of the non-refresh area (or the picture or portion of the picture) is different, use of the methods shown in FIGS. 14-17 will not be sufficient to cover all of the pixels in one or more non-refreshed areas. If the overall size or overall shape dimensions for the refreshed area versus the picture (or picture portion or non-refreshed area) are proportional different (to not be able to cover all of the pixels in one or more non-refreshed areas with the use of the methods shown in FIGS. 14-17 alone), features as described below may be used. In one type of example embodiment, neither the RA shape nor the NRA shape needs to be rectangular or square. In another example embodiment the RA shape might have a 3:4 outside perimeter dimension, and the NRA shape might have a 6:12 outside perimeter dimension. In another example embodiment, the RA and the NRA may have the same horizontal proportions, such as 3:4 and 3:4, but because the RA is smaller in size than the NRA, features as described herein may be used.

A third example embodiment may be provided where, for CUs in a refreshed area(s) of a current picture:
1. pixels in refreshed area(s) of the current picture and associated reference pictures may be repeated into the non-refreshed area(s) of the current picture and associated reference pictures horizontally first, and
2. subsequently, if necessary, pixels in refreshed area(s) of the current picture and associated reference pictures, as well as the horizontally repeated pixels in non-refreshed areas of the current picture and associated reference pictures, may be repeated into non-refreshed area(s) of the current picture and associated reference pictures vertically.

This may be done at both the encoder and the decoder.

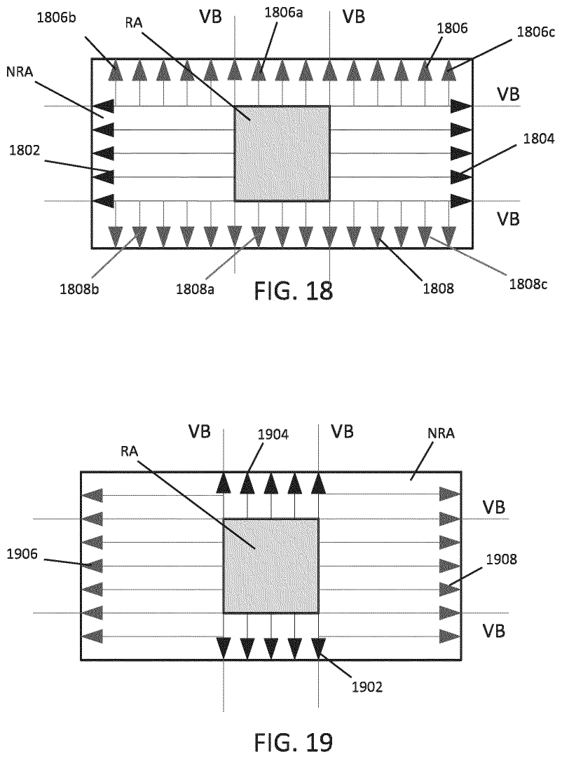

So, if a method, such as described with reference to FIGS. 14-17 above, used as step 1 above, would not be sufficient to cover all of the pixels in one or more non-refreshed areas, the step 2 may be used to result in all of the pixels in one or more non-refreshed areas eventually being covered. Step 2 not only uses pixels from the refreshed area. Step 2 uses pixels from repeated pixels which have been previously repeated into the non-refreshed area(s) of the current picture and associated reference pictures. Two examples are described with reference to FIGS. 18 and 19 below.

In the example of FIG. 18, a GDR/recovering picture is divided into a refreshed area (RA) and a non-refreshed area (NRA) by four (4) virtual boundaries (VB); two vertical virtual boundaries and two horizontal virtual boundaries. A refreshed area is located in a center of the GDR/recovering picture. Neither horizontally repeating alone nor vertically repeating alone of pixels in refreshed area into non-refreshed area will be able to cover all the non-refreshed area pixels. Thus, step 1 noted above will not be sufficient to result in all of the pixels in one or more non-refreshed areas eventually being covered.

With the third example embodiment, and with reference to FIG. 18, horizontally repeating of pixels in the refreshed area into non-refreshed area may be performed first as indicated with arrows 1802 and 1804. Specifically, the left boundary pixels in refreshed area are repeated into non-refreshed area horizontally from right as illustrated with arrows 1802, and the right boundary pixels in the refreshed area may be repeated into non-refreshed area horizontally from left as illustrated with arrows 1804. Subsequently, vertically repeating of pixels into the non-refreshed area may be performed next. Specifically, the upper boundary pixels in the refreshed area and the previously horizontally repeated pixels in the non-refreshed area that are on the same row as the upper boundary pixels in refreshed area may be repeated into the non-refreshed area vertically from below as illustrated with arrows 1806, and the lower boundary pixels in the refreshed area and the horizontally repeated pixels in non-refreshed area that are on the same row as the lower boundary pixels in refreshed area may be repeated into non-refreshed area vertically from above as illustrated with arrows 1808. Thus, not only are pixels from the refreshed area repeated into the non-refreshed area, but previously repeated pixels in the non-refreshed area are also repeated again into the non-refreshed area in the subsequent second step. As shown, 1806a is directly from the top side of the RA, 1806b is from the top side of 1802 and 1806c is from the top side of 1804. Likewise, 1808a is directly from the bottom side of the RA, 1806b is from the bottom side of 1802 and 1806c is from the bottom side of 1804.

With a fourth example embodiment, as illustrated with FIG. 19, for CUs in a refreshed area of a current picture:
1. pixels in refreshed areas of the current picture and associated reference pictures may be repeated into non-refreshed areas of the current picture and associated reference pictures vertically first as indicated with arrows 1902 and 1904, and
2. subsequently, if necessary, pixels in refreshed areas of the current picture and associated reference pictures as well as the vertically repeated pixels in non-refreshed areas of the current picture and associated reference pictures may be repeated into non-refreshed areas of the current picture and associated reference pictures horizontally as indicated with arrows 1906 and 1908.

This may be done at both the encoder and the decoder.

FIG. 19 shows an example for GDR with a refreshed area starting in the center, where a GDR/recovering picture is divided into a refreshed area (RA) and a non-refreshed area (NRA) by four virtual boundaries (VB). As seen in FIG. 19, neither horizontally repeating alone nor vertically repeating alone of pixels in refreshed area into non-refreshed area will be able to cover all the non-refreshed area pixels. With the fourth example embodiment, as illustrated with FIG. 19, vertically repeating of pixels in refreshed area into non-refreshed area may be performed first. Specifically, the upper boundary pixels in the refreshed area may be repeated into the non-refreshed area vertically from below, and the lower boundary pixels in the refreshed may be repeated into non-refreshed area vertically from above, as shown by the vertical arrows in FIG. 19. Subsequently, horizontally repeating of pixels into the non-refreshed area may be performed next. Specifically, the left boundary pixels in the refreshed area and the vertically repeated pixels in non-refreshed area that are on the same column as the left boundary pixels in refreshed area may be repeated into the non-refreshed area horizontally from right, and the right boundary pixels in refreshed area and the vertically repeated pixels that are the same column as the right boundary pixels in the refreshed area may be repeated into non-refreshed area horizontally from left, as shown by the horizontal arrows in FIG. 19.

It should be noted that the four example embodiments described above are not intended to be limiting in regards to directions and order of directions for repeatings. In addition, with flexible GDR, it is also possible that there are more than one refreshed area in a GDR/recovering picture. In these cases, pixels in refreshed areas of a current picture or reference picture may be repeated into one or more non-refreshed area in more than one direction. Hence, it can be ambiguous or selectable or configurable which pixel should be used to replace the value of corresponding pixel in non-refreshed area.

A more general example embodiment is that for CUs in a refreshed area of a current picture, when there is a need,
1. use the pixels in a refreshed area of a current picture to derive/replace the values of pixels in non-refreshed area(s) of the current picture, and
2. use the pixels in the refreshed area of associated reference pictures to derive/replace the values of non-reference areas of one or more associated reference picture(s),

This may occur at both the encoder and the decoder.

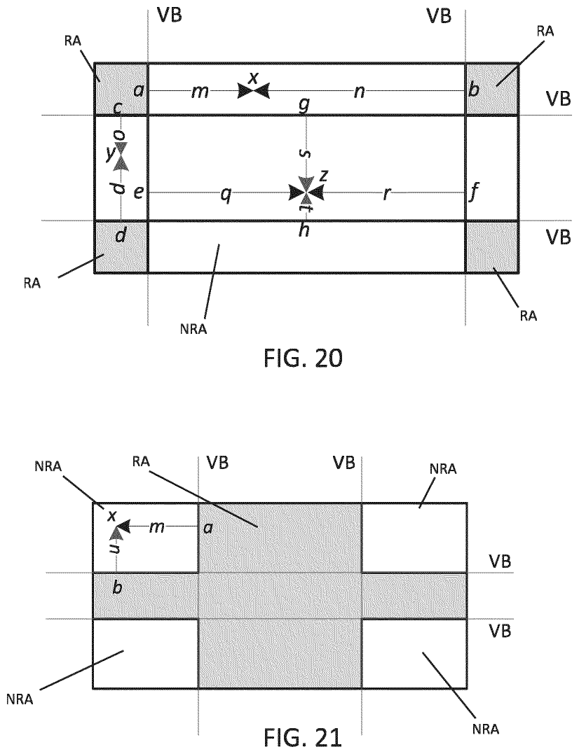

FIG. 20 shows an example for GDR with four refreshed areas starting from four corners, where a GDR/recovering picture is divided into four separate refreshed areas (RA) and non-refreshed area (NRA) by four virtual boundaries (VB). From FIG. 20, it can be observed that:
1. neither horizontally repeating alone nor vertically repeating alone of pixels from the refreshed areas into the non-refreshed area will be able to cover all the non-refreshed area pixels, and
2. pixels in the refreshed area may be repeated into the non-refreshed area in two directions which are not necessarily opposite to each other; both horizontally and vertically. It does not matter if the directions are opposite (see FIGS. 18-19 for example) or not opposite (see FIGS. 20 and 21 for example).

With the more general embodiment, for the example of FIG. 20,
1. pixels in top-left refreshed area and top-right refreshed area may be used to derive/replace the values of pixels in upper portion of non-refreshed area,
2. pixels in bottom-left refreshed area and bottom-right refreshed area may be used to derive/replace the values of pixels in lower portion of non-refreshed area,
3. pixels in top-left refreshed area and bottom-left refreshed area may be used to derive/replace the values of pixels in left portion of non-refreshed area,
4. pixels in top-right refreshed area and bottom-right refreshed area may be used to derive/replace the values of pixels in right portion of non-refreshed area, and
5. then, pixels with replaced values in upper, lower, left and right portions of non-refreshed area may be used to derive/replace the values of pixels in center portion of non-refreshed area.

For example, the value of pixel x in upper portion of non-refreshed area may be replaced by a value derived from pixel a in top-left refreshed area and pixel b in top-right refreshed area as,

$$value ( x ) = \frac{{w}_{a} \times value ( a ) + {w}_{b} \times value ( b )}{{w}_{a} + {w}_{b}} \qquad ( 1 )$$

where wₐ and w_{b} are the weights for pixel a and pixel b, respectively. A specific example formula may be

$$value ( x ) = \frac{n \times value ( a ) + m \times value ( b )}{n + m} \qquad ( 2 )$$

where m and n are the distances to pixel x from the pixel a position and pixel b position, respectively.

Similarly, the value of pixel y in left portion of non-refreshed area may be replaced by a value derived from pixel c in top-left refreshed area and pixel d in bottom-left refreshed area as,

$$value ( y ) = \frac{{w}_{c} \times value ( c ) + {w}_{d} \times value ( a )}{{w}_{c} + {w}_{d}} \qquad ( 3 )$$

where w_{c} and w_{d} are the weights for pixel c and pixel d, respectively. A specific formula may be, for example,

$$value ( y ) = \frac{p \times value ( c ) + o \times value ( a )}{p + o} \qquad ( 4 )$$

where o and p are the distances to the pixel y from the pixel c position and the pixel d position, respectively.

As another example, the value of pixel z in the center portion of non-refreshed area may be replaced by a value derived from pixels e, f, g and h in the left, right, upper and lower portions of non-refreshed area as

$$value ( y ) = \frac{\begin{matrix}{w}_{e} \times value ( e ) + {w}_{f} \times value ( f ) + \\ {w}_{g} \times value ( g ) + {w}_{h} \times value ( h )\end{matrix}}{{w}_{e} + {w}_{f} + {w}_{9} + {w}_{h}} \qquad ( 5 )$$

where wₐ, w_{b}, w_{c} and w_{d} are the weights for replaced-value pixels e, f, g and h, respectively. Note that the values of pixels e, f, g and h in the left, right, upper and lower portions of non-refreshed area have already been replaced by the values derived from the pixels in refreshed areas. A specific formula can be

$$value ( y ) = \frac{\begin{matrix}( t + s ) ( r \times value ( e ) + q \times value ( f ) ) + \\ ( r + q ) ( t \times value ( g ) + s \times v a l u ( h ) )\end{matrix}}{( r + q ) + ( t + s )} \qquad ( 6 )$$

where q, r, s and t are the distances to the pixel z from the positions of pixels e, f, g and h, respectively.

FIG. 21 show another example. In this example GDR starts with the refreshed area starting from the center with a non-square shape and non-rectangular shape, where a GDR/recovering picture is divided into a refreshed area (RA) and four (4) non-refreshed areas (NRA) by four virtual boundaries (VB).

With the more general embodiment, for the example of FIG. 21,
1. the values of pixels in the top-left non-refreshed area may be replaced by the values derived from its lower and right neighbouring pixels in refreshed area,
2. the values of pixels in the top-right non-refreshed area may be replaced by the values derived from its lower and left neighbouring pixels in refreshed area,
3. the values of pixels in the bottom-left non-refreshed area may be replaced by the values derived from its upper and right neighbouring pixels in refreshed area,
4. the values of pixels in the bottom-right non-refreshed area may be replaced by the values derived from its upper and left neighbouring pixels in refreshed area,

For example, the value of pixel x in the top-left non-refreshed area may be replaced by a value derived from (with use of) more than one other pixel. In this example, the value may be derived from its left neighboring pixel a and lower neighboring pixel b in the refreshed area as,

$$value ( x ) = \frac{{w}_{a} \times value ( a ) + {w}_{b} \times value ( b )}{{w}_{a} + {w}_{b}} \qquad ( 7 )$$

where wₐ and w_{b} are the weights for pixel a and pixel b, respectively. A specific formula may be, for example,

$$value ( x ) = \frac{n \times value ( a ) + m \times value ( b )}{n + m} \qquad ( 8 )$$

where m and n are the distances to pixel x from the position of pixel a and the position of pixel b, respectively.

In all the embodiments discussed above, none of the non-refreshed area pixels are part of coding of CUs in a refreshed area of the current picture. With additional setting of coding mode per block in non-refreshed areas of the current picture and associated reference pictures, coding modes in VVC and ECM may be implemented for CUs in a refreshed area of a current picture normally without leaks or mismatch between the encoder and the decoder. In some embodiments deriving or repeating values of pixels in different directions may be sequential in time and/or concurrent in time.

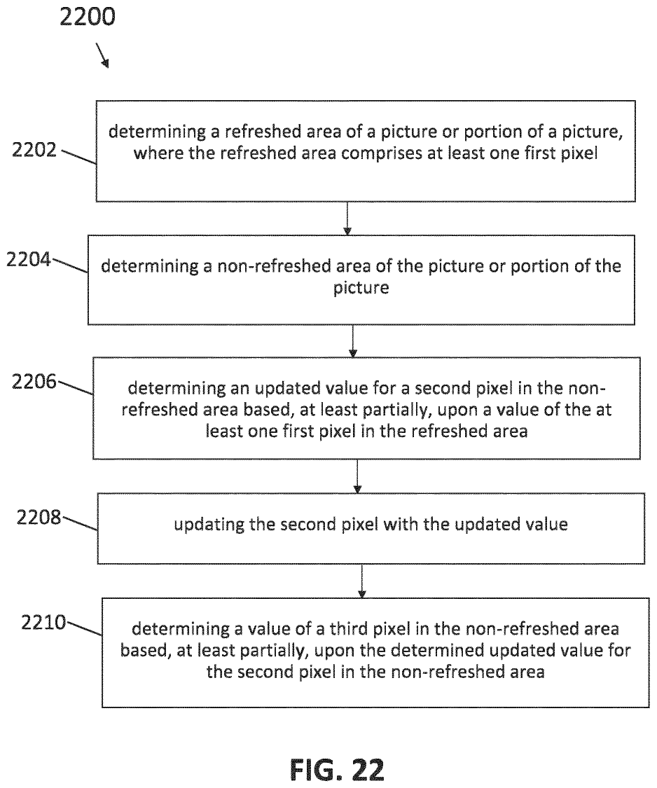

Referring also to FIG. 22, an example embodiment may be provided with a method 2200 comprising: determining a refreshed area of a picture or portion of a picture, where the refreshed area comprises at least one first pixel as illustrated with block 2202; determining a non-refreshed area of the picture or portion of the picture as illustrated with block 2204; determining an updated value for a second pixel in the non-refreshed area based, at least partially, upon a value of the at least one first pixel in the refreshed area as illustrated with block 2206; updating the second pixel with the updated value as illustrated with block 2208; and determining a value of a third pixel in the non-refreshed area based, at least partially, upon the determined updated value for the second pixel in the non-refreshed area as illustrated with block 2210.

The determining of the refreshed area and the non-refreshed area may comprise use of at least two virtual boundaries. The at least two virtual boundaries may comprise a first virtual boundary and a second virtual boundary, where the first virtual boundary is spaced from the second virtual boundary. The at least two virtual boundaries may comprise a first virtual boundary and a second virtual boundary, where the first virtual boundary is parallel with the second virtual boundary. The at least two virtual boundaries may comprise a first virtual boundary and a second virtual boundary, where the first virtual boundary is perpendicular with the second virtual boundary. The at least two virtual boundaries may comprise a first virtual boundary and a second virtual boundary, where the first virtual boundary is angled relative to the second virtual boundary. The at least two virtual boundaries may comprise a first virtual boundary and a second virtual boundary, where the first virtual boundary intersects the second virtual boundary. The at least two virtual boundaries may comprise a first virtual boundary and a second virtual boundary, where refreshed area is adjacent both the first and second virtual boundaries. The at least two virtual boundaries may comprise more than two of the virtual boundaries. The at least two virtual boundaries may comprise at least two first virtual boundaries which are at least partially spaced from one another, at least two second virtual boundaries which are at least partially spaced from one another, and where at least one of the first virtual boundaries intersect with at least one of the second virtual boundaries. The determining of the updated value of the second pixel may comprise replacing an original value of the second pixel with the value of the at least one first pixel. The determining of the updated value of the second pixel may comprise deriving the updated value of the second pixel at least partially based upon the value of the at least one first pixel. The deriving of the updated value may comprise use of the value of the at least one first pixel and use of a value of at least one other pixel. The deriving of the updated value may comprise using the value of at least two of the first pixels. The at least two first pixels may be spaced from one another. The refreshed area may comprise two portions which are spaced from one another with a portion of the non-refreshed area therebetween. The non-refreshed area may comprise two portions which are spaced from one another with a portion of the refreshed area therebetween. The refreshed area may comprise a non-rectangular shape. The refreshed area may comprise a non-square shape. The non-refreshed area may comprise an outer perimeter with a non-rectangular shape. A shape of the refreshed area may be proportionally different relative to a shape of the non-refreshed area. Replacing and/or deriving of original values of pixels in the non-refreshed area only directly from the refreshed area, vertically or horizontally, may not cover all pixels in the non-refreshed area. The determining of the refreshed area and the non-refreshed area may comprise use of at least two virtual boundaries, where the at least two virtual boundaries comprise a first virtual boundary and a second virtual boundary, where the updating of the second pixel comprising: replacing pixels in the non-refreshed area based upon pixels proximate the first virtual boundary as the first virtual boundary moves in a first direction; and replacing pixels in the non-refreshed area based upon pixels proximate the second virtual boundary as the second virtual boundary moves in a second direction. The first direction may be the same as the second direction. The first direction may be different from the second direction. The first direction may be opposite to the second direction. The method may further comprise updating the third pixel in the non-refreshed area based, at least partially, upon the determined updated value for the second pixel in the non-refreshed area, where the updating of the third pixel comprises one of: repeating the updated value from the second pixel in a third direction perpendicular to the first direction, or deriving the updated value from the second pixel in the third direction perpendicular to the first direction. The method may further comprise: determining a second updated value for a fourth pixel in the non-refreshed area based, at least partially, upon a value of a pixel in the refreshed area; updating the fourth pixel with the second updated value; and determining a value of a fifth pixel in the non-refreshed area based, at least partially, upon the determined second updated value for the fourth pixel in the non-refreshed area. The method may further comprise one of: repeating the second updated value from the fourth pixel in a different fourth direction perpendicular to the first direction, or deriving the second updated value from the fourth pixel in the different fourth direction perpendicular to the first direction. The determining of the updated value for the second pixel in the non-refreshed area may comprise use of a value of a first one of the first pixels from a first section of the refreshed area and use of a value of a second one of the first pixels from a second section of the refreshed area. The first and second sections may be spaced from one another. The first and second sections may be opposite one another with a portion of the non-refreshed area, having the second pixel, therebetween. The second pixel may be between the first one of the first pixels and the second one of the first pixels. A first direction of the first one of the first pixels to the second pixel and a second direction of the second one of the first pixels to the second pixel may be opposite directions. The method may further comprise determining a second updated value for a fourth pixel in the non-refreshed area comprising use of a value of a third one of the first pixels from a third section of the refreshed area and use of a value of a fourth one of the first pixels from a fourth section of the refreshed area. The method may further comprise determining a third updated value for a fifth pixel in the non-refreshed area comprising using the updated value and the second updated value. The determining of the third updated value for the fifth pixel may comprise use of at least one other updated value of a pixel in the non-refreshed area. The updated values may be from at least three different directions. The three different directions may include two directions which are opposite and one direction which is perpendicular to the opposite directions. The first and second sections may be generally perpendicular relative to one another but not separate from one another. A first direction of the first one of the first pixels to the second pixel and a second direction of the second one of the first pixels to the second pixel may be perpendicular directions.

An example embodiment may be provided with an apparatus comprising: at least one processor; and at least one non-transitory memory storing instructions that, when executed with the at least one processor, cause the apparatus to perform: determining a refreshed area of a picture or portion of a picture, where the refreshed area comprises at least one first pixel; determining a non-refreshed area of the picture or portion of the picture; determining an updated value for a second pixel in the non-refreshed area based, at least partially, upon a value of the at least one first pixel in the refreshed area; updating the second pixel with the updated value; and determining a value of a third pixel in the non-refreshed area based, at least partially, upon the determined updated value for the second pixel in the non-refreshed area.

The determining of the refreshed area and the non-refreshed area may comprise use of at least two virtual boundaries. The at least two virtual boundaries may comprise a first virtual boundary and a second virtual boundary, where the first virtual boundary is spaced from the second virtual boundary. The at least two virtual boundaries may comprise a first virtual boundary and a second virtual boundary, where the first virtual boundary is parallel with the second virtual boundary. The at least two virtual boundaries may comprise a first virtual boundary and a second virtual boundary, where the first virtual boundary is perpendicular with the second virtual boundary. The at least two virtual boundaries may comprise a first virtual boundary and a second virtual boundary, where the first virtual boundary is angled relative to the second virtual boundary. The at least two virtual boundaries may comprise a first virtual boundary and a second virtual boundary, where the first virtual boundary intersects the second virtual boundary. The at least two virtual boundaries may comprise a first virtual boundary and a second virtual boundary, where refreshed area is adjacent both the first and second virtual boundaries. The at least two virtual boundaries may comprise more than two of the virtual boundaries. The at least two virtual boundaries may comprise at least two first virtual boundaries which are at least partially spaced from one another, at least two second virtual boundaries which are at least partially spaced from one another, and where at least one of the first virtual boundaries intersect with at least one of the second virtual boundaries. The determining of the updated value of the second pixel may comprise replacing an original value of the second pixel with the value of the at least one first pixel. The determining of the updated value of the second pixel may comprise deriving the updated value of the second pixel at least partially based upon the value of the at least one first pixel. The deriving of the updated value may comprise use of the value of the at least one first pixel and use of a value of at least one other pixel. The deriving of the updated value may comprise using the value of at least two of the first pixels. The at least two first pixels may be spaced from one another. The refreshed area may comprise two portions which are spaced from one another with a portion of the non-refreshed area therebetween. The non-refreshed area may comprise two portions which are spaced from one another with a portion of the refreshed area therebetween. The refreshed area may comprise a non-rectangular shape. The refreshed area may comprise a non-square shape. The non-refreshed area comprises an outer perimeter with a non-rectangular shape. A shape of the refreshed area may be proportionally different relative to a shape of the non-refreshed area. Replacing and/or deriving of original values of pixels in the non-refreshed area only directly from the refreshed area, vertically or horizontally, may not cover all pixels in the non-refreshed area. The determining of the refreshed area and the non-refreshed area may comprise use of at least two virtual boundaries, where the at least two virtual boundaries comprise a first virtual boundary and a second virtual boundary, where the updating of the second pixel comprising: replacing pixels in the non-refreshed area based upon pixels proximate the first virtual boundary as the first virtual boundary moves in a first direction; and replacing pixels in the non-refreshed area based upon pixels proximate the second virtual boundary as the second virtual boundary moves in a second direction. The first direction may be the same as the second direction. The first direction may be different from the second direction. The first direction may be opposite to the second direction. The instructions, when executed with the at least one processor, may cause the apparatus to perform updating the third pixel in the non-refreshed area based, at least partially, upon the determined updated value for the second pixel in the non-refreshed area, where the updating of the third pixel comprises one of: repeating the updated value from the second pixel in a third direction perpendicular to the first direction, or deriving the updated value from the second pixel in the third direction perpendicular to the first direction. The instructions, when executed with the at least one processor, may cause the apparatus to perform: determining a second updated value for a fourth pixel in the non-refreshed area based, at least partially, upon a value of a pixel in the refreshed area; updating the fourth pixel with the second updated value; and determining a value of a fifth pixel in the non-refreshed area based, at least partially, upon the determined second updated value for the fourth pixel in the non-refreshed area. The instructions, when executed with the at least one processor, may cause the apparatus to perform one of: repeating the second updated value from the fourth pixel in a different fourth direction perpendicular to the first direction, or deriving the second updated value from the fourth pixel in the different fourth direction perpendicular to the first direction. The determining of the updated value for the second pixel in the non-refreshed area may comprise use of a value of a first one of the first pixels from a first section of the refreshed area and use of a value of a second one of the first pixels from a second section of the refreshed area. The first and second sections may be spaced from one another. The first and second sections may be opposite one another with a portion of the non-refreshed area, having the second pixel, therebetween. The second pixel may be between the first one of the first pixels and the second one of the first pixels. A first direction of the first one of the first pixels to the second pixel, and a second direction of the second one of the first pixels to the second pixel, may be opposite directions. The instructions, when executed with the at least one processor, may cause the apparatus to perform determining a second updated value for a fourth pixel in the non-refreshed area comprising use of a value of a third one of the first pixels from a third section of the refreshed area and use of a value of a fourth one of the first pixels from a fourth section of the refreshed area. The instructions, when executed with the at least one processor, may cause the apparatus to perform determining a third updated value for a fifth pixel in the non-refreshed area comprising using the updated value and the second updated value. The determining of the third updated value for the fifth pixel may comprise use of at least one other updated value of a pixel in the non-refreshed area. The updated values may be from at least three different directions. The three different directions may include two directions which are opposite and one direction which is perpendicular to the opposite directions. The first and second sections may be generally perpendicular relative to one another but not separate from one another. A first direction of the first one of the first pixels to the second pixel, and a second direction of the second one of the first pixels to the second pixel, may be perpendicular directions.

An example embodiment may be provided with an apparatus comprising: means for determining a refreshed area of a picture or portion of a picture, where the refreshed area comprises at least one first pixel; means for determining a non-refreshed area of the picture or portion of the picture; means for determining an updated value for a second pixel in the non-refreshed area based, at least partially, upon a value of the at least one first pixel in the refreshed area; means for updating the second pixel with the updated value; and means for determining a value of a third pixel in the non-refreshed area based, at least partially, upon the determined updated value for the second pixel in the non-refreshed area.

An example embodiment may be provided with a non-transitory program storage device readable by an apparatus, tangibly embodying a program of instructions executable with the apparatus for performing operations, the operations comprising: determining a refreshed area of a picture or portion of a picture, where the refreshed area comprises at least one first pixel; determining a non-refreshed area of the picture or portion of the picture; determining an updated value for a second pixel in the non-refreshed area based, at least partially, upon a value of the at least one first pixel in the refreshed area; updating the second pixel with the updated value; and determining a value of a third pixel in the non-refreshed area based, at least partially, upon the determined updated value for the second pixel in the non-refreshed area.

The term “non-transitory,” as used herein, is a limitation of the medium itself (i.e., tangible, not a signal) as opposed to a limitation on data storage persistency (e.g., RAM vs. ROM).

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
(i) a combination of analog and/or digital hardware circuit(s) with software/firmware and
(ii) any portions of hardware processor(s) with software (including digital signal processor(s)), software, and memory(ies) that work together to cause an apparatus, such as a mobile phone or server, to perform various functions) and
(iii) hardware circuit(s) and or processor(s), such as a microprocessor(s) or a portion of a microprocessor(s), that requires software (e.g., firmware) for operation, but the software may not be present when it is not needed for operation.”

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

It should be understood that the foregoing description is only illustrative. Various alternatives and modifications can be devised by those skilled in the art. For example, features recited in the various dependent claims could be combined with each other in any suitable combination(s). In addition, features from different embodiments described above could be selectively combined into a new embodiment. Accordingly, the description is intended to embrace all such alternatives, modifications and variances which fall within the scope of the appended claims.

1-84. (canceled)

85. An apparatus comprising: at least one processor, and at least one memory storing instructions that, when executed with the at least one processor, cause the apparatus at least to perform: determining a refreshed area of a picture or portion of a picture, where the refreshed area comprises at least one first pixel; determining a non-refreshed area of the picture or portion of the picture; determining an updated value for a second pixel in the non-refreshed area based, at least partially, upon a value of the at least one first pixel in the refreshed area; updating the second pixel with the updated value; and determining a value of a third pixel in the non-refreshed area based, at least partially, upon the determined updated value for the second pixel in the non-refreshed area.

86. The apparatus of claim 85, wherein the determining of the refreshed area and the non-refreshed area comprises use of at least two virtual boundaries.

87. The apparatus of claim 86, wherein the at least two virtual boundaries comprise a first virtual boundary and a second virtual boundary, the first virtual boundary being at least one of the following: spaced from the second virtual boundary; parallel with the second virtual boundary; perpendicular to the second virtual boundary; angled relative to the second virtual boundary; or intersecting the second virtual boundary.

88. The apparatus of claim 86, wherein the at least two virtual boundaries comprise a first virtual boundary and a second virtual boundary, wherein the refreshed area is adjacent both the first and second virtual boundaries.

89. The apparatus of claim 86, wherein the at least two virtual boundaries comprise at least two first virtual boundaries which are at least partially spaced from one another, at least two second virtual boundaries which are at least partially spaced from one another, and wherein at least one of the first virtual boundaries intersect with at least one of the second virtual boundaries.

90. The apparatus of claim 85, wherein the determining of the updated value for the second pixel comprises replacing an original value of the second pixel with the value of the at least one first pixel.

91. The apparatus of claim 85, wherein the determining of the updated value for the second pixel comprises deriving the updated value of the second pixel at least partially based upon the value of the at least one first pixel.

92. The apparatus of claim 91, wherein the deriving of the updated value comprises use of the value of the at least one first pixel and use of a value of at least one other pixel.

93. The apparatus of claim 85, wherein the refreshed area comprises two portions which are spaced from one another with a portion of the non-refreshed area therebetween.

94. The apparatus of claim 85, wherein the non-refreshed area comprises two portions which are spaced from one another with a portion of the refreshed area therebetween.

95. The apparatus of claim 85, wherein the refreshed area comprises a non-rectangular shape.

96. The apparatus of claim 85, wherein the non-refreshed area comprises an outer perimeter with a non-rectangular shape.

97. The apparatus of claim 85, wherein the determining of the refreshed area and the non-refreshed area comprises use of at least two virtual boundaries, wherein the at least two virtual boundaries comprise a first virtual boundary and a second virtual boundary, wherein the updating of the second pixel comprises: replacing pixels in the non-refreshed area based upon pixels proximate the first virtual boundary as the first virtual boundary moves in a first direction; and replacing pixels in the non-refreshed area based upon pixels proximate the second virtual boundary as the second virtual boundary moves in a second direction.

98. The apparatus of claim 97, further being caused to perform: updating the third pixel in the non-refreshed area based, at least partially, upon the determined updated value for the second pixel in the non-refreshed area, wherein the updating of the third pixel comprises one of: repeating the updated value from the second pixel in a third direction perpendicular to the first direction; or deriving the updated value from the second pixel in the third direction perpendicular to the first direction.

99. The apparatus of claim 98, further being caused to perform: determining a second updated value for a fourth pixel in the non-refreshed area based, at least partially, upon a value of a pixel in the refreshed area; updating the fourth pixel with the second updated value; and determining a value of a fifth pixel in the non-refreshed area based, at least partially, upon the determined second updated value for the fourth pixel in the non-refreshed area.

100. The apparatus of claim 85, wherein the determining of the updated value for the second pixel in the non-refreshed area comprises use of a value of a first one of the first pixels from a first section of the refreshed area and use of a value of a second one of the first pixels from a second section of the refreshed area.

101. The apparatus of claim 100, further being caused to perform: determining a second updated value for a fourth pixel in the non-refreshed area comprising use of a value of a third one of the first pixels from a third section of the refreshed area and use of a value of a fourth one of the first pixels from a fourth section of the refreshed area.

102. The apparatus of claim 101, further being caused to perform: determining a third updated value for a fifth pixel in the non-refreshed area comprising using the updated value and the second updated value.

103. The apparatus of claim 100, wherein a first direction of the first one of the first pixels to the second pixel and a second direction of the second one of the first pixels to the second pixel are perpendicular directions.

104. A method comprising: determining a refreshed area of a picture or portion of a picture, where the refreshed area comprises at least one first pixel; determining a non-refreshed area of the picture or portion of the picture; determining an updated value for a second pixel in the non-refreshed area based, at least partially, upon a value of the at least one first pixel in the refreshed area; updating the second pixel with the updated value; and determining a value of a third pixel in the non-refreshed area based, at least partially, upon the determined updated value for the second pixel in the non-refreshed area.
